(19) United States
(12) Patent Application Publication
(10) Pub. No.: US 2012/0069227 A1
(43) Pub. Date: Mar. 22, 2012

(54) IMAGE READING DEVICE FOR READING IMAGE DATA

(76) Inventor: Tomotake HASUO, Yokohama-shi (JP)

(21) Appl. No.: 13/091,536

(22) Filed: Apr. 21, 2011

(30) Foreign Application Priority Data
Sep. 21, 2010 (JP) 2010-211275

(51) Int. Cl. H04N 5/217

(52) U.S. Cl. 348/243; 348/E05.079

(57) ABSTRACT

According to one embodiment, an image reading device is disclosed. The reference memory stores reference signals of tone levels “0” to “n” which are output from the sensor by light of tone levels “0” to “n” reflected by the shading plate. The afterimage memory stores afterimage signals of tone levels “1” to “n” which are output from the sensor after the sensor outputs the reference signals. The image signal memory store image signals of first and second lines. The afterimage correction memory store the afterimage signals of tone levels “n−1” and “n” when the image signal of the first line is not smaller than the reference signal of tone level “n−1”, and smaller than the reference signal of tone level “n”. The signal processor performs afterimage correction on the image signal of the second line by calculation using at least the afterimage signals of tone levels “n−1” and “n”.

### CROSS-REFERENCE TO RELATED APPLICATIONS

This application is based upon and claims the benefit of priority from Japanese Patent Application No. 2010-211275, filed Sep. 21, 2010; the entire contents of which are incorporated herein by reference.

### FIELD

Embodiments described herein relate generally to an image reading device for reading image data.

### BACKGROUND

In a conventional technique, there is known a method for using white reference data, black reference data, and afterimage data stored in a line memory to execute shading correction in a scanned image and correction (to be referred to as afterimage correction hereinafter) for removing the influence of an afterimage.

If, however, only shading correction and afterimage correction using white reference data, black reference data, and afterimage data are performed, the influence of variations in linearity within a sensor chip or those in linearity between chips in a sensor module with a plurality of sensors may appear on an image as variations in density.

### BRIEF DESCRIPTION OF THE DRAWINGS

FIG. 1 is a block diagram showing the arrangement of an image reading device according to a first embodiment;

FIG. 2 is a timing chart showing an operation for acquiring afterimage signals and shading reference signals in the image reading device according to the first embodiment;

FIG. 3 is a flowchart illustrating the operation for acquiring afterimage signals and shading reference signals in the image reading device according to the first embodiment;

FIG. 4 is a view showing a shading plate of the image reading device according to the first embodiment;

FIG. 5 is a flowchart illustrating an image scanning operation in the image reading device according to the first embodiment;

FIG. 6 is a flowchart illustrating the image scanning operation in the image reading device according to the first embodiment;

FIG. 7 is a flowchart illustrating the image scanning operation in the image reading device according to the first embodiment;

FIG. 8 is a flowchart illustrating the image scanning operation in the image reading device according to the first embodiment;

FIG. 9 is a graph showing calculation for afterimage correction according to the first embodiment;

FIGS. 10A and 10B are graphs showing calculation for shading correction according to the first embodiment;

FIG. 11 is a flowchart illustrating an operation for acquiring afterimage signals and shading data in an image reading device according to a second embodiment; and

FIG. 12 is a view showing a shading plate of the image reading device according to the second embodiment.

### DETAILED DESCRIPTION

An image reading device according to embodiments will be described below with reference to the accompanying drawings. In the following description, the same reference numerals denote the same parts throughout the drawings.

In general, according to one embodiment, an image reading device includes an image sensor, a shading plate, a reference memory, an afterimage memory, an image signal memory, an afterimage correction memory, and a signal processor. The image sensor has light receiving elements arranged in line in a main scan direction perpendicular to a sub-scan direction. The image sensor is configured to read an image of lines in the main scan direction by a reading operation in the sub-scan direction. The shading plate reflects light emitted by a light source. The reference memory stores reference signals of tone levels “0” to “n” (n is a natural number of 1 or more) which are output from the image sensor by light of tone levels “0” to “n” reflected by the shading plate, respectively. The afterimage memory stores afterimage signals of tone levels “1” to “n” which are output from the image sensor after the image sensor outputs the reference signals of tone levels “1” to “n”, respectively. The image signal memory store an image signal of a first line and an image signal of a second line succeeding the first line, which have been read by the image sensor. The afterimage correction memory store the afterimage signal of tone level “(n−1)” and the afterimage signal of tone level “n” stored in the afterimage memory when the image signal of the first line is not smaller than the reference signal of tone level “(n−1)”, and smaller than the reference signal of tone level “n”. The signal processor performs afterimage correction on the image signal of the second line by calculation using at least the afterimage signal of tone level “(n−1)” and the afterimage signal of tone level “n”, which are stored in the afterimage correction memory.

According to another embodiment, an image reading method is disclosed. The method can store, in a reference memory, reference signals of tone levels “0” to “n” (n is a natural number of 1 or more) which are output from an image sensor by light of tone levels “0” to “n” reflected by a shading plate, respectively. The method can store, in an afterimage memory, afterimage signals of tone levels “1” to “n” which are output from the image sensor after the image sensor outputs the reference signals of tone levels “1” to “n”, respectively. The method can store, in an image signal memory, an image signal of a first line and an image signal of a second line succeeding the first line, which have been read by the image sensor. The method can store, in an afterimage correction memory, the afterimage signal of tone level “(n−1)” and the afterimage signal of tone level “n” stored in the afterimage memory when the image signal of the first line is not smaller than the reference signal of tone level “(n−1)”, and smaller than the reference signal of tone level “n”. In addition, the method can cause a signal processor to perform afterimage correction on the image signal of the second line by calculation using at least the afterimage signal of tone level “(n−1)” and the afterimage signal of tone level “n”, which are stored in the afterimage correction memory.

### [1] First Embodiment

An image reading device according to the first embodiment will be described first.

[1-1] Arrangement

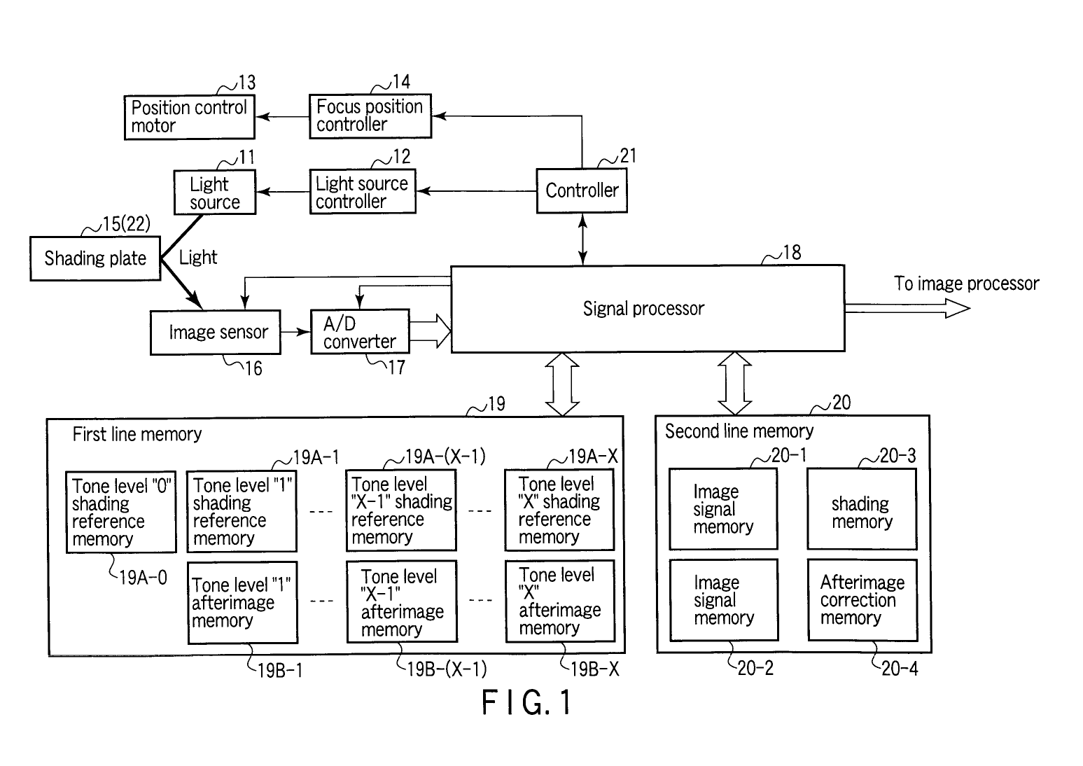

FIG. 1 is a block diagram showing the arrangement of an image reading device according to the first embodiment.

As shown in FIG. 1, the image reading device has a light source 11, a light source controller 12, a position control motor 13, a focus position controller 14, a shading plate 15, an image sensor 16, an analog/digital (A/D) converter 17, a signal processor 18, a first line memory 19, a second line memory 20, and a controller 21.

The light source 11 can adjust an amount of light, and irradiates a reading object to undergo an image reading operation, for example, a document sheet, or the shading plate 15 with light of a plurality of tone levels. The light source controller 12 controls an amount of light emitted by the light source 11, and also controls to turn on or off the light source 11. The focus position controller 14 causes the position control motor 13 to move the image sensor 16, and controls a reading position on the document sheet.

The shading plate 15 is monochrome with a predetermined tone level, and is used for shading correction. The image sensor 16 serves as a line sensor with light receiving elements arranged in line, which receives light reflected by the document sheet or the shading plate 15, and generates an image signal through photoelectric conversion. The A/D converter 17 converts the image signal (analog signal) generated by the image sensor 16 into a digital signal. Note that a CCD image sensor, a CMOS image sensor, or the like is used as the image sensor 16.

The signal processor 18 receives the image signal (digital signal) converted by the A/D converter 17, and performs calculation processing on the image signal. The image signal processed by the signal processor 18 is output to the first line memory 19 and the second line memory 20, and stored in them. The image signal processed by the signal processor 18 is output to a subsequent image processor. The signal processor 18 includes a custom IC such as an ASIC (Application Specific Integrated Circuit). The signal processor 18 drives the image sensor 16 and A/D converter 17, accesses the first line memory 19 and second line memory 20, calculates/acquires data for afterimage correction and those for shading correction, performs calculation for afterimage correction and shading correction of the image signal, and so on.

The first line memory 19 has, as storage areas, a tone level “0” shading reference memory 19A-0, a tone level “1” shading reference memory 19A-1, . . . , a tone level “X−1” shading reference memory 19A-(X−1), and a tone level “X” shading reference memory 19A-X. These memory areas store shading reference signals of tone levels “0” (black), “1”, . . . , “X−1”, and “X” output from the signal processor 18, respectively.

Furthermore, the first line memory 19 has, as storage areas, a tone level “1” afterimage memory 19B-1, . . . . , a tone level “X−1” afterimage memory 19B-(X−1), and a tone level “X” afterimage memory 19B-X. These memory areas store afterimage signals of tone levels “1”, . . . , “X−1”, and “X” output from the signal processor 18, respectively. The first line memory 19 may include a first memory and a second memory. The first memory may include the reference memories 19A-0, 19A-1, . . . , 19A-(X−1), 19A-X. The second memory may include the afterimage memories 19B-1, . . . , 19B-(X−1), 19B-X.

The second line memory 20 has, as storage areas, a first image signal memory 20-1, a second image signal memory 20-2, a shading memory 20-3, and an afterimage correction memory 20-4. These memory areas store various signals output from the signal processor 18.

The controller 21 includes, for example, a CPU, and controls the operation of each component constituting the image reading device.

[1-2] Operation

The image reading device includes the image sensor 16 with light receiving elements arranged in line in a main scan direction perpendicular to a sub-scan direction, and performs an image scan operation for reading an image of a plurality of lines in the main scan direction by a reading operation in the sub-scan direction of the image sensor 16.

In the image scan operation for reading an image from a document sheet, afterimage signals (data for afterimage correction) and shading reference signals (data for shading correction) are acquired in advance, and these signals are used to correct image signals read from the document sheet. The afterimage signals are obtained by subtracting a shading reference signal of tone level “0” from image signals output from the image sensor after the image sensor 16 outputs the shading reference signals of respective tone levels. The shading reference signals serve as reference signals generated by the image sensor when emitting light of respective tone levels. Since an afterimage signal changes depending on the amount of light incident on the image sensor, an afterimage signal corresponding to the amount of incident light (a plurality of tone levels) is obtained for afterimage correction.

An operation for acquiring afterimage signals and shading reference signals will be explained first. Then, an image scan operation for reading an image from a document sheet, that is, an operation for acquiring image data will be described. These operations are executed by the signal processor 18 under the control of the controller 21.

[1-2-1] Acquisition of Afterimage Signals and Shading Reference Signals

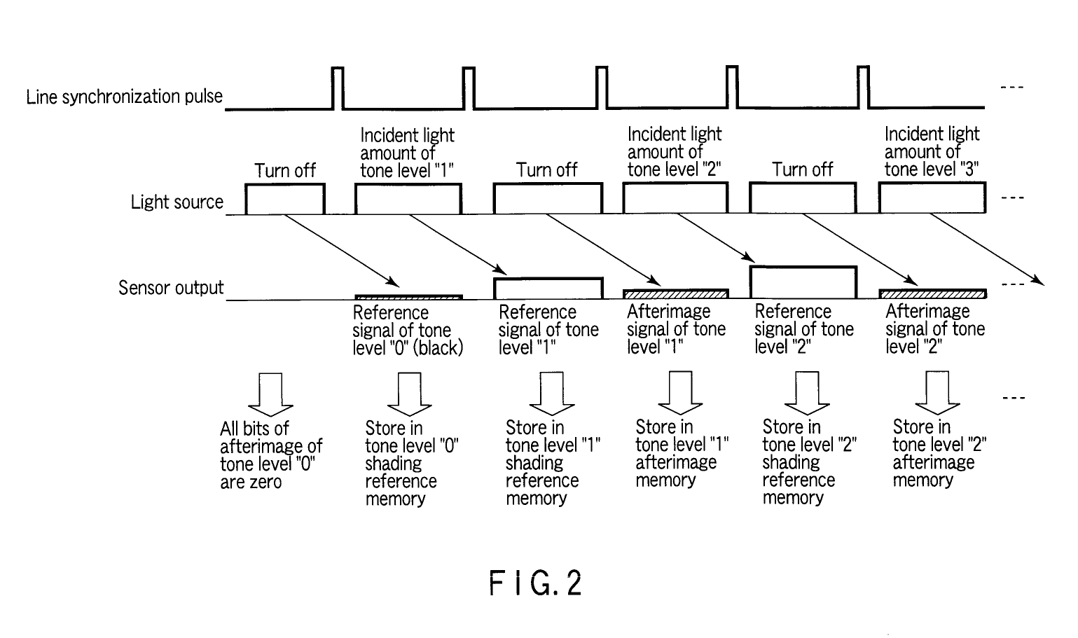

FIG. 2 is a timing chart showing an operation for acquiring afterimage signals and shading reference signals in the image reading device according to the first embodiment. FIG. 2 shows a line synchronization pulse, the tone level control and flicker of the light source 11, and the sensor output timings of the image sensor 16 when acquiring afterimage signals and shading reference signals. The line synchronization pulse is used for synchronizing the operation of the light source 11 and that of the image sensor 16.

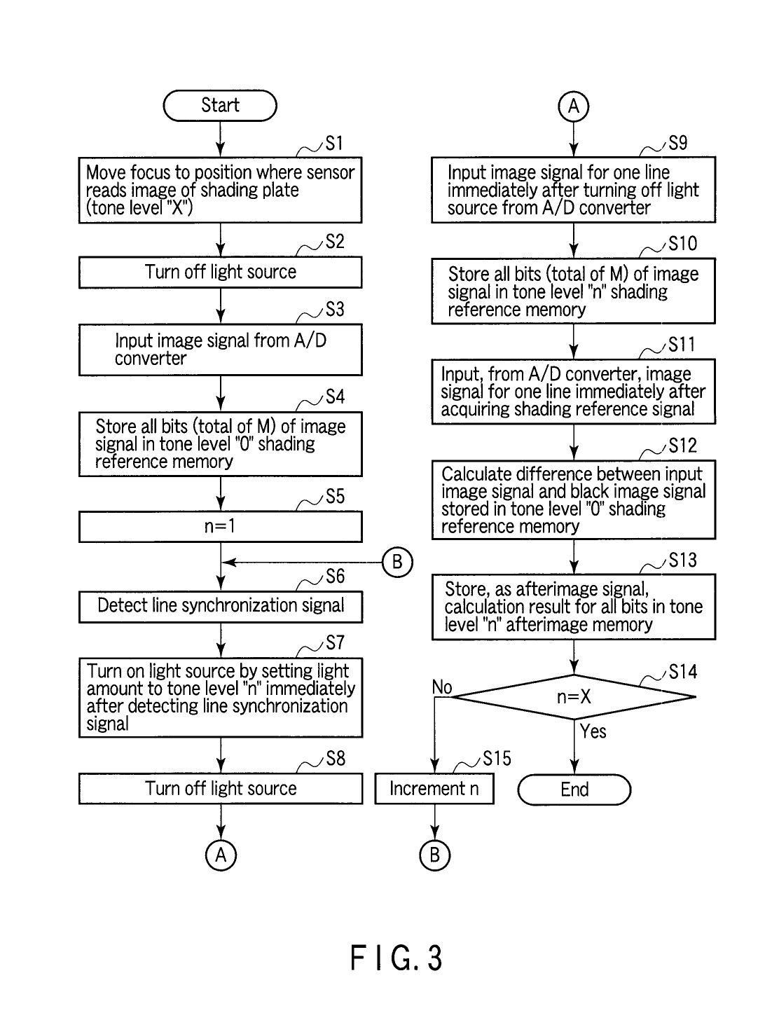

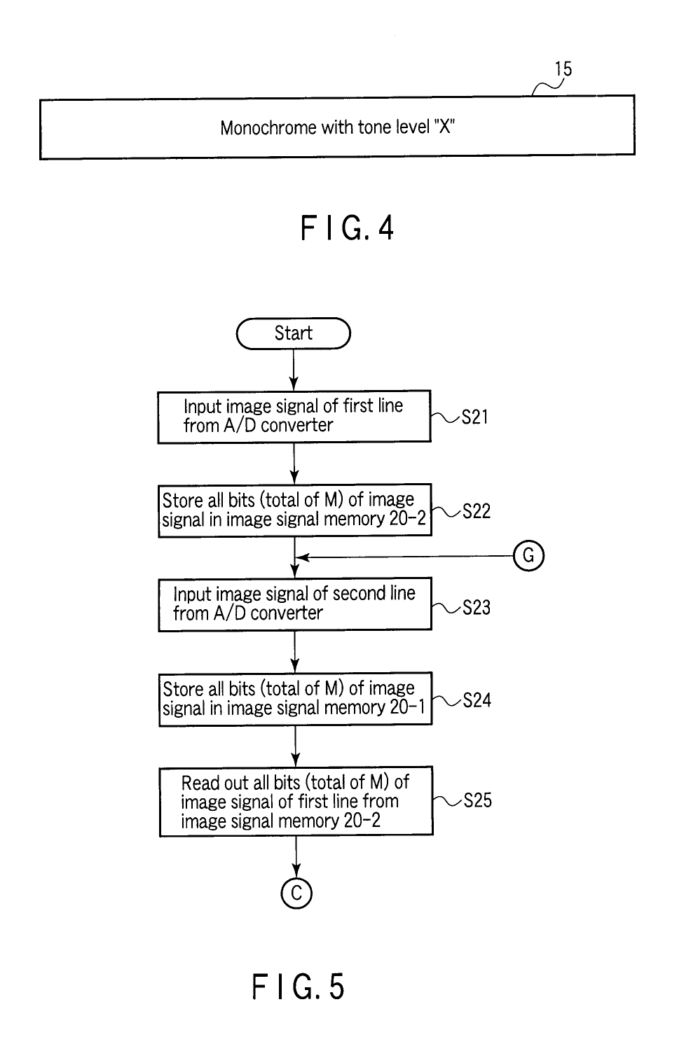

FIG. 3 is a flowchart illustrating the operation for acquiring afterimage signals and shading reference signals in the image reading device. Assume that M denotes the number of pixel bits for one line of the image sensor 16, and (X+1) denotes the number of shading reference signals. FIG. 4 shows the shading plate 15 used in the first embodiment. The shading plate 15 is monochrome with tone level “X”. The operation shown in FIGS. 2 and 3 is executed prior to an image reading operation, for example, upon power-on, or immediately before an image reading operation.

As shown in FIG. 3, the controller 21 causes the image sensor 16 to move the focus of incident light to a position where an image of the shading plate 15 (tone level “X”) is read (step S1). Subsequently, the controller 21 causes the light source controller 12 to turn off the light source 11 (step S2).

The controller 21 then inputs an image signal for one line, immediately after turning off the light source 11, to the signal processor 18 via the A/D converter 17 from the image sensor 16. That is, the controller 21 inputs, as an image signal, a signal which has been output from the image sensor 16 at a tone level of 0 (black) to the signal processor 18 via the A/D converter 17. More specifically, an analog signal which has been output from the image sensor 16 when the light source 11 is off (a tone level of 0) is input to the A/D converter 17. The A/D converter 17 converts the received analog signal into a digital signal, and outputs it to the signal processor 18 (step S3). Subsequently, the controller 21 stores all the bits (a total of M bits) of the image signal in the tone level “0” shading reference memory 19A-0 within the first line memory 19 as a shading reference signal of tone level “0” (step S4).

The controller 21 sets a counter n to 1 (step S5). The counter n (n=0, 1, 2, . . . , X−1, X) represents the tone level of light emitted by the light source 11. The tone levels are 0, 1, 2, . . . , X−1, and X from black to white. The initial value of the counter n is 0.

The controller 21 detects a line synchronization signal (step S6). Immediately after detecting the line synchronization signal, the controller 21 causes the light source controller 12 to set the amount of light of the light source 11 to a tone level of n, and turn on the light source 11 (step S7). Then, immediately after detecting the line synchronization signal, the controller 21 causes the light source controller 12 to turn off the light source 11 (step S8).

The controller 21 inputs an image signal for one line, immediately after turning off the light source 11, from the image sensor 16 to the signal processor 18 via the A/D converter 17. That is, the controller 21 inputs, as an image signal, a signal which has undergone photoelectric conversion in the image sensor 16 at a tone level of n to the signal processor 18 via the A/D converter 17 (step S9). The controller 21 stores all the bits (a total of M bits) of the image signal input to the signal processor 18 in the tone level “n” shading reference memory 19A-n within the line memory 19 as a shading reference signal of tone level “n” (step S10).

Immediately after the image signal is stored in the tone level “n” shading reference memory 19A-n, that is, the shading reference signal of tone level “n” is output from the image sensor 16, the controller 21 inputs another image signal for one line output next from the image sensor 16 to the signal processor 18 via the A/D converter 17 (step S11). Ideally, no electrical charge should be accumulated in the image sensor 16. However, not all electrical charges are output, and some electrical charges remain. In step S11, it is possible to input an afterimage signal of tone level “n” by inputting the remaining electrical charges. The controller 21 causes the signal processor 18 to calculate the difference between the image signal input to the signal processor 18 in step S11 and the black image signal (shading reference signal of tone level “0”) stored in the tone level “0” shading reference memory 19A-0 (step S12). The controller 21 then stores the calculation result for all the bits (a total of M bits) of one line in the tone level “n” afterimage memory 19B-n as an afterimage signal (step S13).

The controller 21 determines whether the counter n is X (step S14). That is, the controller 21 determines whether all processes for tone levels of 0 to X are complete. If the counter n is not X, the counter n is incremented (step S15). The process then returns to step S6 to repeat the processing in step S6 and thereafter. Alternatively, if the counter n is X, the process ends.

[1-2-2] Acquisition of Image Data

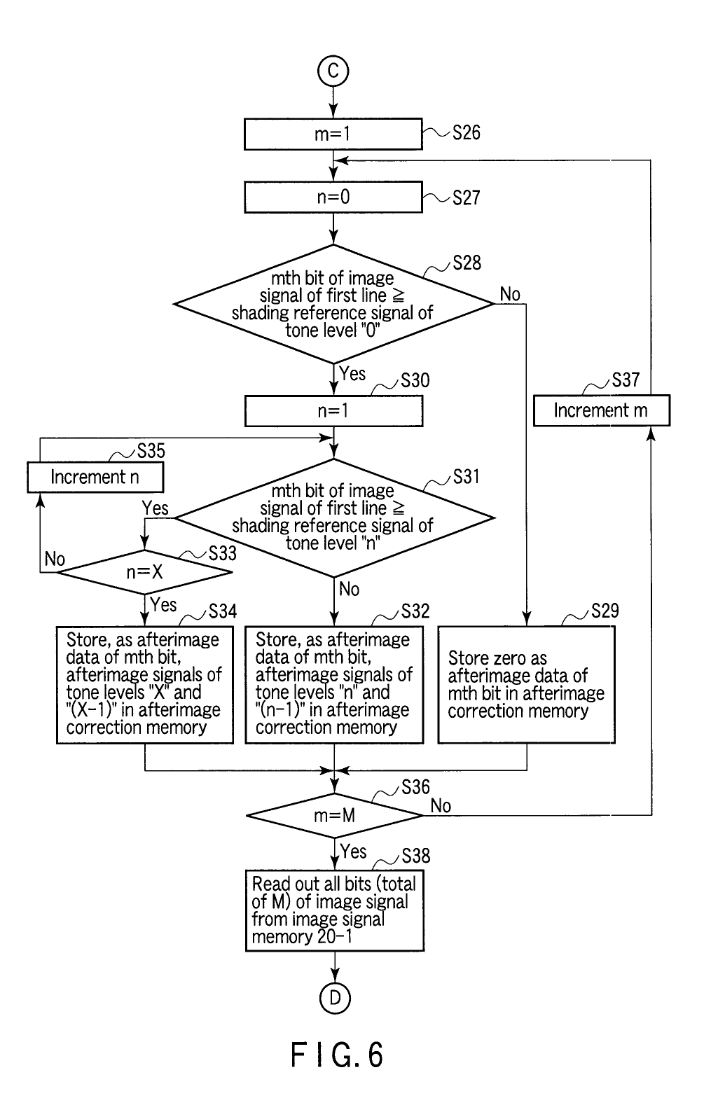

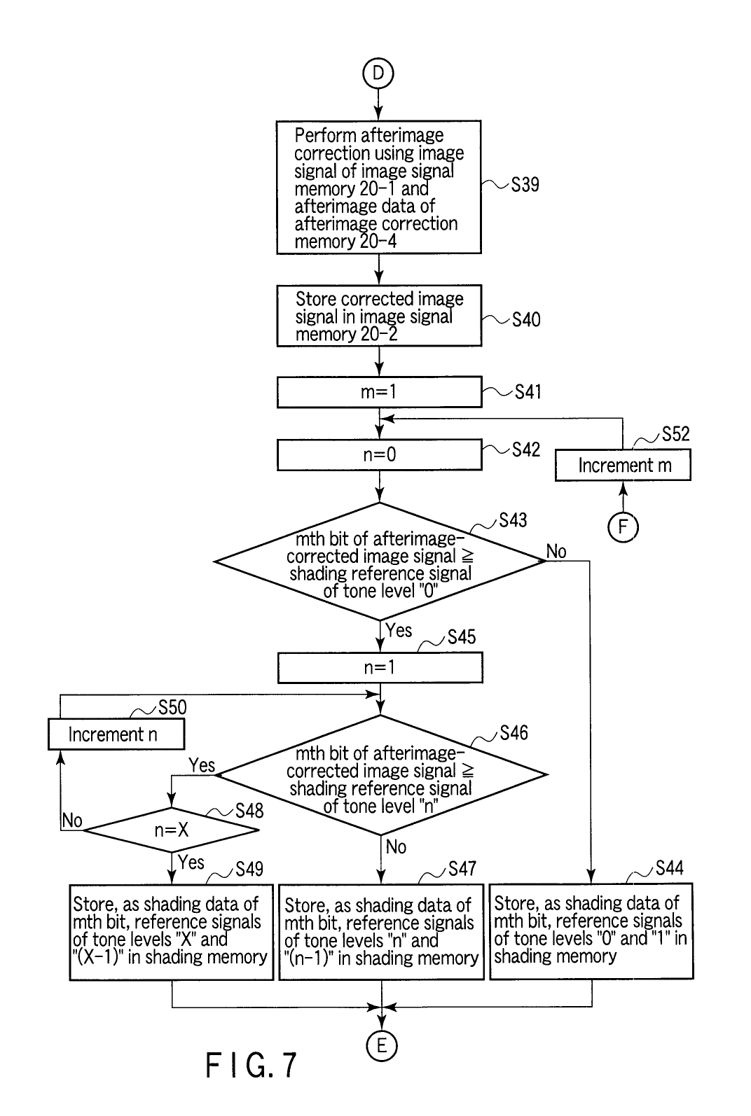

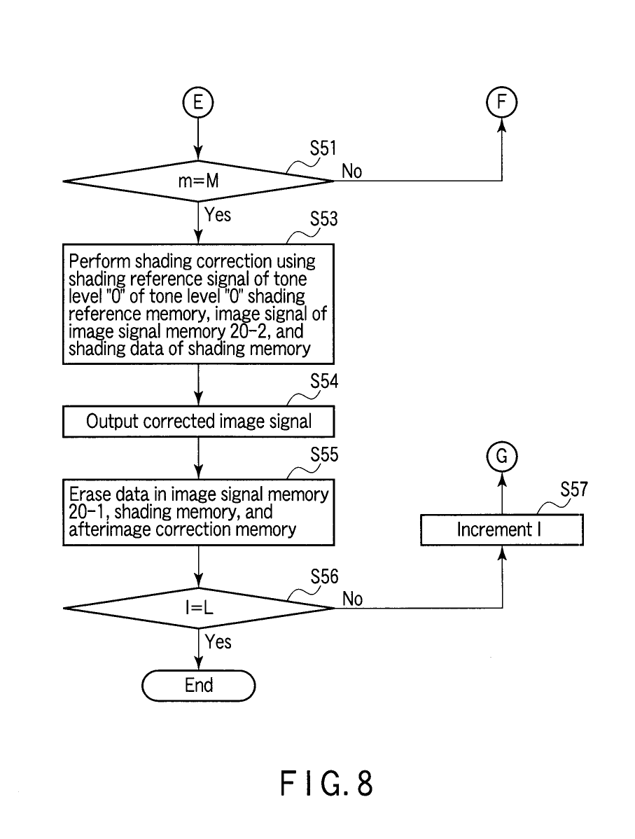

FIGS. 5 to 8 are flowcharts illustrating an operation for acquiring image data in image scanning in the image reading device according to the first embodiment. In this example, image data which has been read in an image scanning operation is corrected using the previously acquired afterimage signals and shading reference signals. A case in which M denotes the number of pixel bits of one line of the image sensor 16, L denotes the number of lines on a document sheet in image scanning, and (X+1) denotes the number of shading data will be explained. Assume that all the bits of the afterimage signal of tone level “0” are 0.

The controller 21 inputs an image signal of the first line on a document sheet to the signal processor 18 via the A/D converter 17 from the image sensor 16 (step S21). After that, the controller 21 stores all the bits (a total of M bits) of the image signal in the image signal memory 20-2 within the line memory 20 (step S22).

The controller 21 inputs an image signal of the second line on the document sheet to the signal processor 18 via the A/D converter 17 from the image sensor 16 (step S23). The second line is a line adjacent to the first line in scanning; a line an image of which is input subsequent to the first line. The controller 21 stores all the bits of the image signal (a total of M bits) in the image signal memory 20-1 within the line memory 20 (step S24). Furthermore, the controller 21 reads all the bits (a total of M bits) of the image signal of the first line from the image signal memory 20-2 into the signal processor 18 (step S25).

The controller 21 sets a counter m to 1 (step S26). The counter m represents the number of pixel bits on one line of the image sensor 16. The controller 21 also sets the counter n to 0 (step S27).

The controller 21 determines whether “the mth bit of the image signal of the first line”≧“the shading reference signal of tone level “0”” is satisfied (step S28).

If “the mth bit of the image signal of the first line”≧“the shading reference signal of tone level “0”” is not satisfied in step S28, the controller 21 stores 0 as afterimage data of the mth bit in the afterimage correction memory 20-4 (step S29).

If “the mth bit of the image signal of the first line”≧“the shading reference signal of tone level “0”” is satisfied in step S28, the controller 21 sets the counter n to 1 (step S30). The controller 21 determines whether “the mth bit of the image signal of the first line”≧“the shading reference signal of tone level “n”” is satisfied (step S31).

If “the mth bit of the image signal of the first line”≧“the shading reference signal of tone level “n”” is not satisfied in step S31, the controller 21 stores, as afterimage data of the mth bit, the afterimage signals of tone levels “n” and “(n−1)” from the afterimage memories within the first line memory 19 into the afterimage correction memory 20-4 (step S32).

If “the mth bit of the image signal of the first line”≧“the shading reference signal of tone level “n”” is satisfied in step S31, the controller 21 determines whether the counter n is X (step S33). If the counter n is X, the controller 21 stores, as afterimage data of the mth bit, the afterimage signals of tone levels “X” and “(X−1)” from the afterimage memories within the first line memory 19 into the afterimage correction memory 20-4 (step S34). Alternatively, if the counter n is not X, the counter n is incremented (step S35) and the process returns to step S31.

After the processing in step S29, S32, or S34, the process advances to step S36. In step S36, the controller 21 determines whether the counter m is M. That is, the controller 21 determines whether the processing for all the pixels of one line is complete. If the counter m is not M, the counter m is incremented (step S37) and the process returns to step S27.

Alternatively, if the counter m is M in step 336, the controller 21 reads out all the bits (a total of M bits) of the image signal from the image signal memory 20-1 (step S38). The controller 21 performs afterimage correction using the image signal read out from the image signal memory 20-1 and the afterimage data stored in the afterimage correction memory 20-4 (step S39). Calculation for afterimage correction will be described in detail later. After afterimage correction, the controller 21 stores the acquired image signal in the image signal memory 20-2 (step S40).

The controller 21 sets the counter m to 1 (step S41). The controller 21 also sets the counter n to 0 (step S42). The controller 21 then determines whether “the mth bit of the afterimage-corrected image signal”≧“the shading reference signal of tone level “0”” is satisfied (step S43).

If “the mth bit of the afterimage-corrected image signal”≧“the shading reference signal of tone level “0”” is not satisfied in step S43, the controller 21 stores, as shading data of the mth bit, the shading reference signals of tone levels “0” and “1” from the shading reference memories within the first line memory 19 into the shading memory 20-3 (step S44).

If “the mth bit of the afterimage-corrected image signal”≧“the shading reference signal of tone level “0”” is satisfied in step S43, the controller 21 sets the counter n to 1 (step S45).

The controller 21 determines whether “the mth bit of the afterimage-corrected image signal”≧“the shading reference signal of tone level “n”” is satisfied (step S46). If it is not satisfied, the controller 21 stores, as shading data of the mth bit, the shading reference signals of tone levels “n” and “(n−1)” from the shading reference memories within the first line memory 19 into the shading memory 20-3 (step S47).

If “the mth bit of the afterimage-corrected image signal”≧“the shading reference signal of tone level “n”” is satisfied in step S46, the controller 21 determines whether the counter n is X (step S48). If the counter n is X, the controller 21 stores, as shading data of the mth bit, the shading reference signals of tone levels “X” and “(X−1)” from the shading reference memories within the first line memory 19 into the shading memory 20-3 (step S49).

Alternatively, if the counter n is not X in step S48, the counter n is incremented (step S50) and the process returns to step S46.

After the processing in step S44, S47, or S49, the process advances to step S51. In step S51, the controller 21 determines whether the counter m is M. That is, the controller 21 determines whether the processing for all the pixels of one line is complete. If the counter m is not M, the counter m is incremented (step S52) and the process returns to step S42.

Alternatively, if the counter m is M in step S51, the controller 21 performs shading correction using the shading reference signal of tone level “0” stored in the tone level “0” shading reference memory 19A-0, the image signal stored in the image signal memory 20-2, and the shading data stored in the shading memory 20-3 (step S53). Calculation for shading correction will be described in detail later.

The controller 21 outputs the shading-corrected image data from the signal processor 18 (step S54). After that, the controller 21 erases data stored in the image signal memory 20-1, shading memory 20-3, and afterimage correction memory 20-4, respectively (step S55).

The controller 21 determines whether a counter I is L (step S56). The counter I represents the number of lines in a document sheet in image scanning. If the counter I is not L, the counter I is incremented (step S57) and the process returns to step S23.

Alternatively, if the counter I is L, the image scan processing ends.

[1-2-3] Calculation for Afterimage Correction

Calculation for afterimage correction performed in step S39 will be described in detail below.

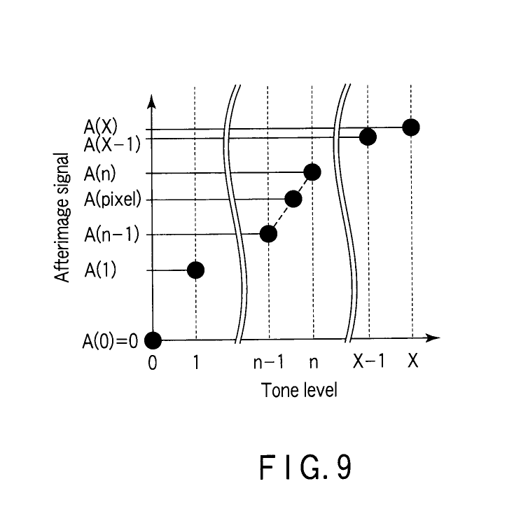

FIG. 9 is a graph showing calculation for afterimage correction according to the first embodiment.

Let B(pixel) be an afterimage-corrected image signal of the first line, B(n−1) be an afterimage-corrected image signal of the first line at a tone level of (n−1), and B(n) be an afterimage-corrected image signal of the first line at a tone level of n. Let A(pixel) be an estimate value of an afterimage signal contained in the image signal, A(n−1) be an afterimage signal at a tone level of (n−1), and A(n) be an afterimage signal at a tone level of n. Furthermore, let C(pixel) be an afterimage-corrected image signal, and D(pixel) be an image signal before afterimage correction. Note that B(n−1)≧B(pixel)<B(n).

At this time, it is possible to calculate the afterimage-corrected image signal C(pixel) according to equations (1) to (4).

$$\begin{matrix}B ( pixel ) = \{ B ( n ) - B ( n - 1 ) \} \cdot Z ( pixel ) + B ( n - 1 ) & ( 1 ) \\ Z ( pixel ) = \frac{B ( pixel ) - B ( n - 1 )}{B ( n ) - B ( n - 1 )} & ( 2 ) \\ A ( pixel ) = \{ A ( n ) - A ( n - 1 ) \} \cdot Z ( pixel ) + A ( n - 1 ) = \{ A ( n ) - A ( n - 1 ) \} \cdot \frac{B ( pixel ) - B ( n - 1 )}{B ( n ) - B ( n - 1 )} + A ( n - 1 ) & ( 3 ) \\ C ( pixel ) = D ( pixel ) - A ( pixel ) & ( 4 )\end{matrix}$$

[1-2-4] Calculation for Shading Correction

Calculation for shading correction performed in step S53 will now be explained in detail.

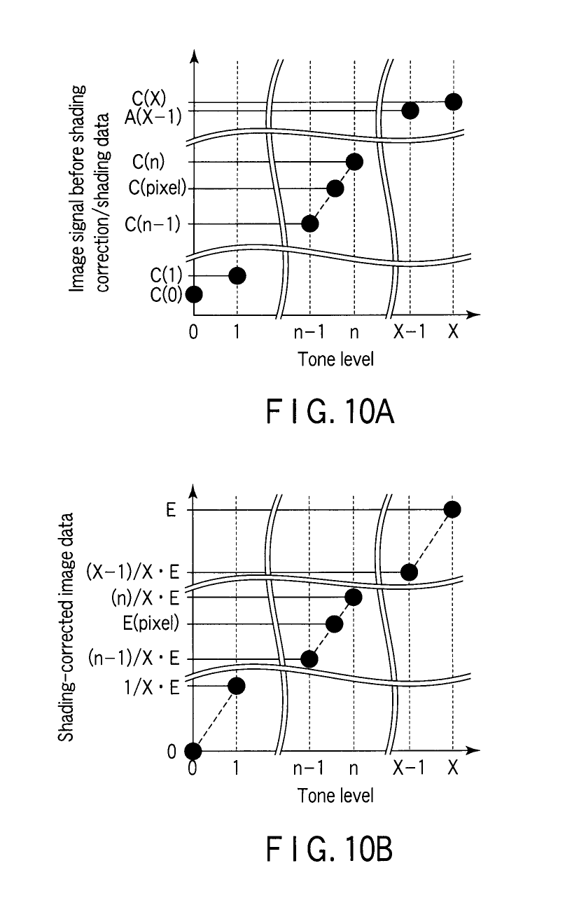

FIGS. 10A and 10B are graphs showing calculation for shading correction according to the first embodiment.

Let C(pixel) be an afterimage-corrected image signal, C(n−1) be shading data at a tone level of (n−1), and C(n) be shading data at a tone level of n. Furthermore, let E(pixel) be a shading-corrected image signal, E(n−1)=(n−1)/X·E be a shading-corrected image signal at a tone level of (n−1), and E(n)=n/X·E be a shading-corrected image signal at a tone level of n. Note that C(n−1)≧C(pixel)<C(n).

At this time, it is possible to calculate the shading-corrected image signal E(pixel) according to equations (5) to (7).

$$\begin{matrix}C ( pixel ) = \{ C ( n ) - C ( n - 1 ) \} \cdot Y ( pixel ) + C ( n - 1 ) & ( 5 ) \\ Y ( pixel ) = \frac{C ( pixel ) - C ( n - 1 )}{C ( n ) - C ( n - 1 )} & ( 6 ) \\ E ( pixel ) = \{ E ( n ) - E ( n - 1 ) \} \cdot Y ( pixel ) + E ( n - 1 ) = \{ \frac{n}{X} \cdot E - \frac{n - 1}{X} \cdot E \} \cdot \frac{C ( pixel ) - C ( n - 1 )}{C ( n ) - C ( n - 1 )} + \frac{n - 1}{X} \cdot E = \frac{E}{X} \{ \frac{C ( pixel ) - C ( n - 1 )}{C ( n ) - C ( n - 1 )} + ( n - 1 ) \} & ( 7 )\end{matrix}$$

In the first embodiment, in order to acquire data for image correction at a tone level of X+1 between black and white, there is provided a line memory for storing afterimage signals (data for afterimage correction) and shading reference signals (data for shading correction) of tone levels “0” to “X”. There is also provided a light source which can perform flicker control, and emit light of tone levels “0” to “X”. It is possible to suppress image degradation such as variations in density by performing multi-tone afterimage correction and linearity correction (shading correction) using the acquired data for afterimage correction and those for shading correction.

Although a monochrome shading plate (in this case, the tone level is n, that is, white) is used in the first embodiment, the embodiment is not limited to this. A multi-tone shading plate may be used. By combining a shading plate with a small number of tone levels and a light source whose light amount is adjustable, it is possible to acquire shading reference signals and afterimage signals with a larger number of tone levels, thereby achieving more correct image correction.

As described above, according to the first embodiment, it is possible to perform multi-tone afterimage correction and linearity correction. This enables to suppress image degradation such as variations in density.

### [2] Second Embodiment

An image reading device according to the second embodiment will be described next.

In the first embodiment, since a multi-tone (tone levels “0” to “X”) afterimage signal and shading reference signal are acquired by the tone level “X” shading plate, an afterimage signal (data for afterimage correction) and a shading reference signal (data for shading correction) are acquired for each tone level by sequentially emitting light with a different light amount.

In the second embodiment, a case in which an afterimage signal and a shading reference signal are acquired for each tone level by irradiating a multi-tone (tone levels “1” to “X”) shading plate with light of tone level “X”, and reading an image of the multi-tone shading plate will be explained.

[2-1] Arrangement and Operation

The arrangement of the image reading device of the second embodiment is the same as in the first embodiment shown in FIG. 1 except for a multi-tone shading plate 22. Furthermore, an operation for acquiring image data in image scanning is the same as that shown in FIGS. 5 to 10A and 10B. Note that a light source 11 may not have a light amount adjustment function.

[2-1-1] Acquisition of Afterimage Signals and Shading Reference Signals

An operation for acquiring afterimage signals and shading reference signals for respective tone levels by reading an image of the multi-tone (tone levels “1” to “X”) shading plate will be described below.

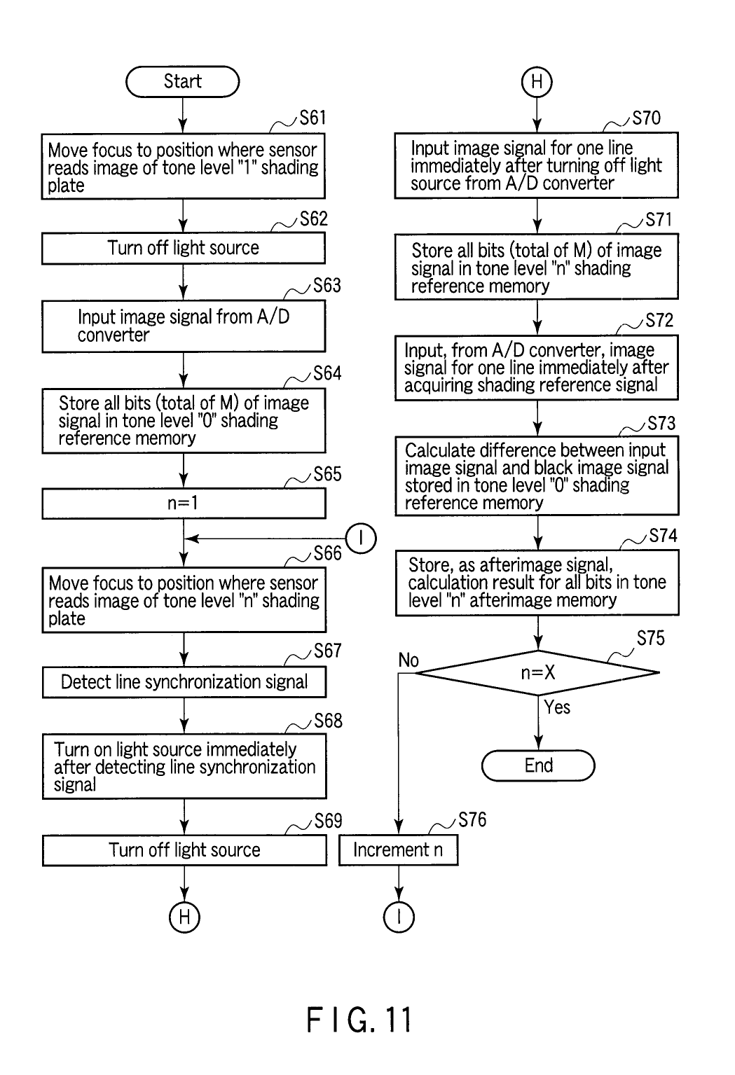

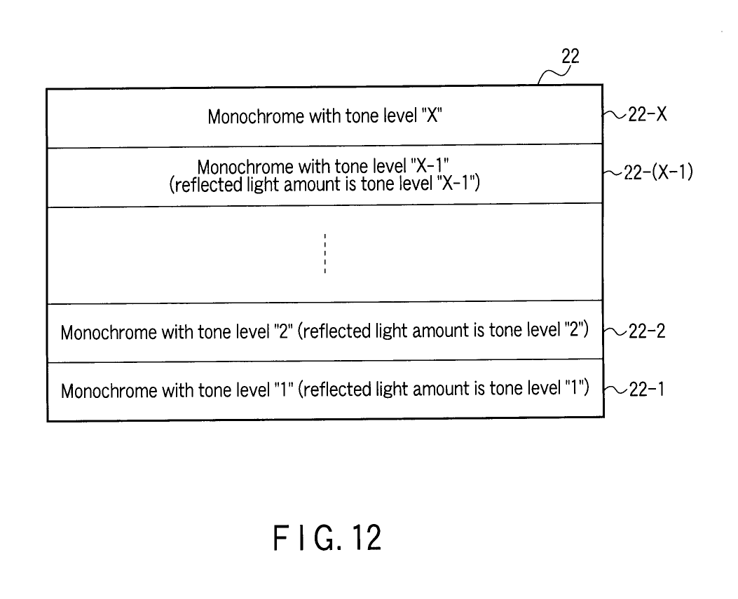

FIG. 11 is a flowchart illustrating an operation for acquiring afterimage signals and shading data in the image reading device according to the second embodiment. Let M be the number of pixel bits of one line of an image sensor 16, and (X+1) be the number of shading reference signals. FIG. 12 is a view showing the multi-tone shading plate 22 used in the second embodiment. The shading plate 22 has a tone level “1” monochrome shading plate 22-1, a tone level “2” monochrome shading plate 22-2, . . . , a tone level “X−1” monochrome shading plate 22-(X−1), and a tone level “X” monochrome shading plate 22-X.

As shown in FIG. 11, a controller 21 causes the image sensor 16 to move the focus of incident light to a position where an image of the shading plate 22 is read (step S61). Subsequently, the controller 21 causes a light source controller 12 to turn off the light source 11 (step S62).

The controller 21 then inputs an image signal for one line, immediately after turning off the light source 11, from the image sensor 16 to a signal processor 18 via an A/D converter 17. That is, the controller 21 inputs, as an image signal, a signal which has been output from the image sensor 16 at a tone level of 0 (black) to the signal processor 18 via the A/D converter 17. More specifically, an analog signal which has been output from the image sensor 16 when the light source 11 is off (a tone level of 0) is input to the A/D converter 17. The A/D converter 17 converts the received analog signal into a digital signal, and outputs it to the signal processor 18 (step S63). Subsequently, the controller 21 stores all the bits (a total of M bits) of the image signal in a tone level “0” shading reference memory 19A-0 within a first line memory 19 as a shading reference signal of tone level “0” (step S64).

The controller 21 sets a counter n to 1 (step S65). The counter n (n=0, 1, 2, . . . , X−1, X) represents the tone level of the shading plate 22. The tone levels are 0, 1, 2, . . . , X−1, and X from black to white. The initial value of the counter n is 0.

The controller 21 causes the image sensor 16 to move the focus of incident light to a position where an image of the tone level “n” shading plate 22-n (in this case, n ranges from 1 to X) is read (step S66). Subsequently, the controller 21 detects a line synchronization signal (step S67). Immediately after detecting the line synchronization signal, the controller 21 causes the light source controller 12 to turn on the light source 11 (step S68). Then, immediately after detecting the line synchronization signal, the controller 21 causes the light source controller 12 to turn off the light source 11 (step S69).

The controller 21 inputs an image signal for one line immediately after turning off the light source 11 to the signal processor 18 via the A/D converter 17 from the image sensor 16. That is, light reflected by the tone level “n” shading plate 22-n undergoes photoelectric conversion in the image sensor 16, and a signal generated by optoelectronic conversion is input, as an image signal, to the signal processor 18 from the A/D converter 17 (step S70). The controller 21 stores all the bits (a total of M bits) of the image signal input to the signal processor 18 in a tone level “n” shading reference memory 19A-n within the line memory 19 as a shading reference signal of tone level “n” (step S71).

Immediately after the image signal is stored in the tone level “n” shading reference memory 19A-n, that is, the shading reference signal of tone level “n” is output from the image sensor 16, the controller 21 inputs a further image signal for one line output from the image sensor 16 to the signal processor 18 from the A/D converter 17 (step S72). Ideally, no electrical charge should be accumulated in the image sensor 16.

However, not all electrical charges are output, and some electrical charges remain. In step S72, it is possible to input an afterimage signal of tone level “n” by inputting the remaining electrical charges. The controller 21 causes the signal processor 18 to calculate the difference between the image signal input to the signal processor 18 in step S72 and the black image signal stored in the tone level “0” shading reference memory 19A-0 (step S73). The controller 21 then stores the calculation result for all the bits of one line in the tone level “n” afterimage memory 19B-n as an afterimage signal (step S74).

The controller 21 determines whether the counter n is X (step S75). That is, the controller 21 determines whether all processes for tone levels of 0 to X are complete. If the counter n is not X, the counter n is incremented (step S76). The process then returns to step S66 to repeat the processing in step S66 and thereafter. Alternatively, if the counter n is X, the process ends.

After that, image data in image scanning is corrected using the acquired afterimage signals and shading reference signals, as shown in FIGS. 5 to 8.

In the second embodiment, in order to acquire data for image correction at a tone level of X+1 between black and white, there is provided a line memory for storing afterimage signals (data for afterimage correction) and shading reference signals (data for shading correction) of tone levels “0” to “X”. There is also provided a monochrome shading plate 22 with tone levels “1”, “2”, . . . , and “X”, and a light source which can perform flicker control. It is possible to suppress image degradation such as variations in density by performing multi-tone afterimage correction and linearity correction (shading correction) using the acquired data for afterimage correction and those for shading correction.

As described above, according to the second embodiment, it is possible to perform multi-tone afterimage correction and linearity correction. This enables to suppress image degradation such as variations in density. The line memory in this embodiment may be integrated in an image sensor module, or a reading device such as a scanner.

According to this embodiment, it is possible to provide an image reading device which suppresses image degradation such as variations in density.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading device comprising:
an image sensor with light receiving elements arranged in line in a main scan direction perpendicular to a sub-scan direction, the image sensor being configured to read an image of lines in the main scan direction by a reading operation in the sub-scan direction;
a shading plate which reflects light emitted by a light source;
a reference memory configured to store reference signals of tone levels “0” to “n” (n is a natural number of 1 or more) which are output from the image sensor by light of tone levels “0” to “n” reflected by the shading plate, respectively;
an afterimage memory configured to store afterimage signals of tone levels “1” to “n” which are output from the image sensor after the image sensor outputs the reference signals of tone levels “1” to “n”, respectively;
an image signal memory configured to store an image signal of a first line and an image signal of a second line succeeding the first line, which have been read by the image sensor;
an afterimage correction memory configured to store the afterimage signal of tone level “(n−1)” and the afterimage signal of tone level “n” stored in the afterimage memory when the image signal of the first line is not smaller than the reference signal of tone level “(n−1)”, and smaller than the reference signal of tone level “n”; and
a signal processor configured to perform afterimage correction on the image signal of the second line by calculation using at least the afterimage signal of tone level “(n−1)” and the afterimage signal of tone level “n”, which are stored in the afterimage correction memory.

2. The device according to claim 1, further comprising:
a shading memory configured to store the reference signal of tone level “(n−1)” and the reference signal of tone level “n” when the image signal of the second line performed afterimage correction by the signal processor is not smaller than the reference signal of tone level “(n−1)”, and smaller than the reference signal of tone level “n”,
wherein the signal processor performs shading correction on the image signal of the second line performed afterimage correction by the signal processor by calculation using at least the reference signal of tone level “(n−1)” and the reference signal of tone level “n”, which are stored in the shading memory.

3. The device according to claim 1, wherein the shading plate has a predetermined tone level, and
the light source irradiates the shading plate with lights of tone levels.

4. The device according to claim 1,
wherein the shading plate has a plurality of tone levels, and
the light source irradiates the shading plate with light of a predetermined tone level.

5. The device according to claim 1,
wherein the afterimage signals of tone levels “1” to “n” stored in the afterimage memory are obtained by subtracting the reference signal of tone level “0” stored in the reference memory from signals output from the image sensor after the image sensor outputs the reference signals of tone levels “1” to “n”, respectively.

6. The device according to claim 1,
wherein the tone level of 0 indicates a black state when the light source is off.

7. The device according to claim 1,
wherein the image sensor includes one of a CCD image sensor and a CMOS image sensor.

8. An image reading method comprising:
storing, in a reference memory, reference signals of tone levels “0” to “n” (n is a natural number of 1 or more) which are output from an image sensor by light of tone levels “0” to “n” reflected by a shading plate, respectively;
storing, in an afterimage memory, afterimage signals of tone levels “1” to “n” which are output from the image sensor after the image sensor outputs the reference signals of tone levels “1” to “n”, respectively;
storing, in an image signal memory, an image signal of a first line and an image signal of a second line succeeding the first line, which have been read by the image sensor;
storing, in an afterimage correction memory, the afterimage signal of tone level “(n−1)” and the afterimage signal of tone level “n” stored in the afterimage memory when the image signal of the first line is not smaller than the reference signal of tone level “(n−1)”, and smaller than the reference signal of tone level “n”; and
causing a signal processor to perform afterimage correction on the image signal of the second line by calculation using at least the afterimage signal of tone level “(n−1)” and the afterimage signal of tone level “n”, which are stored in the afterimage correction memory.

9. The method according to claim 8, further comprising:
storing, in a shading memory, the reference signal of tone level “(n−1)” and the reference signal of tone level “n” when the image signal of the second line performed afterimage correction by the signal processor is not smaller than the reference signal of tone level “(n−1)”, and smaller than the reference signal of tone level “n”; and
causing the signal processor to perform shading correction on the image signal of the second line performed afterimage correction by the signal processor by calculation using at least the reference signal of tone level “(n−1)” and the reference signal of tone level “n”, which are stored in the shading memory.

10. The method according to claim 8,
wherein the shading plate has a predetermined tone level, and
the light source irradiates the shading plate with lights of tone levels.

11. The method according to claim 8,
wherein the shading plate has a plurality of tone levels, and
the light source irradiates the shading plate with light of a predetermined tone level.

12. The method according to claim 8,
wherein the afterimage signals of tone levels “1” to “n” stored in the afterimage memory are obtained by subtracting the reference signal of tone level “0” stored in the reference memory from signals output from the image sensor after the image sensor outputs the reference signals of tone levels “1” to “n”, respectively.

13. The method according to claim 8,
wherein the tone level of 0 indicates a black state when the light source is off.

14. The method according to claim 8,
wherein the image sensor includes light receiving elements arranged in line in a main scan direction perpendicular to a sub-scan direction, and
the image sensor reads an image of lines in the main scan direction by a reading operation in the sub-scan direction.

15. The method according to claim 8,
wherein the image sensor includes one of a CCD image sensor and a CMOS image sensor.
